(19) United States
(12) Patent Application Publication
(10) Pub. No.: US 2001/0033460 A1
(43) Pub. Date: Oct. 25, 2001

(54) Hardened and lubricated load/unload ramp and method for preparing the same

(75) Inventors: Serge Jacques Fayeulle, Longmont, CO (US); Youmin Liu, Palo Alto, CA (US); QiXu (David) Chen, Milpitas, CA (US); Chung Shih, Cupertino, CA (US); Nigel Charles Macleod, Deephaven, MN (US)

Correspondence Address: MERCHANT & GOULD PC, P.O. BOX 2903, MINNEAPOLIS, MN, 55402-0903, US

(73) Assignee: Seagate Technology LLC

(21) Appl. No.: 09/777,270

(22) Filed: Feb. 5, 2001

Related U.S. Application Data
(60) Provisional application No. 60/181,178, filed on Feb. 9, 2000.

(51) Int. Cl. G11B 5/54

(52) U.S. Cl. 360/254.8

(57) ABSTRACT

A disc drive load/unload ramp incorporates a coat of hardened film, the hardened film providing a surface that is more wear resistant and less likely to result in debris formation during normal disc drive use. The hardened surface material, which includes, but is not limited to, DLC, silicon nitrite and titanium carbide, is deposited by sputtering techniques. A disc drive compatible lubricant layer is added to the hardening film to reduce friction. A method of reducing debris formation in a disc drive having a load/unload ramp includes first depositing a hardened film on the load/unload ramp followed by depositing a lubricant layer on the hardened film.

### RELATED APPLICATIONS

This application claims priority of PCT application,Attorney Docket No. STL9487PCT/40046.0099WOU1, filed on Feb. 5, 2001 and United States provisional application Serial No. 60/181,178, filed Feb. 5, 2001.

### Field of the Invention

This application relates generally to magnetic disc drives and more particularly to a load/unload ramp for use in a disc drive.

### BACKGROUND OF THE INVENTION

Disc drives are data storage devices that store digital data in magnetic form on a rotating storage medium on an information storage disc. Modern disc drives comprise one or more rigid information storage discs that are coated with a magnetizable medium and mounted on the hub of a spindle motor for rotation at a constant high speed. Information is stored on the discs in a plurality of concentric circular tracks typically by an array of transducers (“heads”) mounted to a radial actuator for movement of the heads in an arc across the surface of the discs. Each of the concentric tracks is generally divided into a plurality of separately addressable data sectors. The recording transducer, e.g. a magnetoresistive read/write head, is used to transfer data between a desired track and an external environment. During a write operation, data is written onto the disc track and during a read operation the head senses the data previously written on the disc track and transfers the information to a host computing system. The overall capacity of the disc drive to store information is dependent upon the disc drive recording density.

The transducers are mounted on sliders or heads via flexures at the ends of a plurality of actuator arms that project radially outward from the actuator body. The actuator body pivots about a shaft mounted to the disc drive housing at a position closely adjacent the outer extreme of the discs. The pivot shaft is parallel with the axis of rotation of the spindle motor and the discs, so that the transducers move in a plane parallel with the surfaces of the discs.

Typically, such rotary actuators employ a voice coil motor to position the transducers with respect to the disc surfaces. The actuator voice coil motor includes a coil mounted on the side of the actuator body opposite the transducer arms so as to be immersed in the magnetic field of a magnetic circuit comprising one or more permanent magnets and magnetically permeable pole pieces. When controlled direct current (DC) is passed through the coil, an electromagnetic field is set up which interacts with the magnetic field of the magnetic circuit to cause the coil to move in accordance with the well-known Lorentz relationship. As the coil moves, the actuator body pivots about the pivot shaft and the transducers move across the disc surfaces. The actuator thus allows the transducer to move back and forth in an arcuate fashion between an inner radius and an outer radius of the discs.

When a stop-start contact disc drive is de-energized, the transducers are automatically moved to a storage location or “park” location on the disc surfaces. The park location is typically adjacent and outside the inner or outer periphery of the data storage region of the disc and is typically called a landing zone. This landing zone typically does not contain any useable data as the transducer physically contacts the disc at rest. Consequently, any data stored in this area would likely be lost or compromised. In addition, the landing zone is typically roughened to minimize the stiction of the transducer against the disc surface.

Other disc drives utilize load/unload ramps to facilitate the removal of the transducer from the disc to a parked position adjacent the disc. The load/unload ramp in a disc drive is typically stationary and located at a peripheral portion of the information storage disc. Removal of the transducer from the disc media is accomplished by the transducer/suspension assembly moving to the outer rim portion of the disc and then traversing up the inclined portion of the ramp to a park location on the load/unload ramp. As such, the transducer is physically “parked” off of the information storage disc surfaces.

The use of a load/unload ramp to store the transducer under de-energized conditions has several advantages over the use of the traditional landing zone design where the transducer is stored on the disc surface. First, using a load/unload ramp eliminates stiction concerns and friction failures associated with the transducer being de-energized on the landing zone of the disc. Second, information storage disc have a protective carbon overcoat which at least in part is required to support the transducer-landing zone interaction. In the absence of this interaction, a thinner carbon overcoat may be utilized on the disc surface. A thinner carbon overcoat on the information storage disc allows for the design of decreased transducer-to-disc media spacing and for a corresponding increase in recording density. Finally, by parking the transducer head off the information storage disc surface on the load/unload ramp, a larger amount of disc space is available for data storage, which also results in an increased recording density.

However, the use of a load/unload ramp in a disc drive has several disadvantages, one of which is that the numerous interactions between the transducer/suspension assembly and the load/unload ramp causes wear and resultant debris formation on the surfaces of both the load/unload ramp and transducer/suspension assembly. Debris formation inside the disc drive is a major concern in the disc drive industry as it can lead to disc errors and ultimately disc failure. Thus, minimizing friction and wear between the load/unload ramp and the transducer/suspension assembly is a major concern in the disc drive art.

Presently, friction between the load/unload ramp and transducer/suspension assembly is minimized by forming the ramp out of a low friction-low wear plastic and by lubricating the transducer/suspension assembly or more preferably the load/unload ramp with a Teflon™ based lubricant. However, administering the proper amount of lubricant on the load ramp surfaces and of manufacturing a cost effective load/unload ramp with a lubricant film continues to present shortcomings in disc drive art. Against this backdrop the present invention has been developed.

### SUMMARY OF THE INVENTION

In accordance with the present invention the above problems and others have been solved by modifying a load/unload ramp with a hardened film that resists wear and debris formation. A lubricating film is added over the hardened film to reduce friction.

One embodiment of the present invention is a disc drive having an information storage disc rotatably mounted on a spin motor. The disc drive further includes an actuator assembly for directing a transducer over a surface of the information storage disc, and a load/unload ramp. The load/unload ramp is positioned adjacent a peripheral portion of the information storage disc for supporting the transducer when the transducer is off of the information storage disc. The load/unload ramp is coated with a hardened film.

Another embodiment of the present invention is a method of reducing debris formation in a disc drive where the disc drive includes an information storage disc rotatably mounted on a spin motor, an actuator assembly adjacent the information storage disc for directing a transducer over a surface of the information storage disc, and a load/unload ramp adjacent the information storage disc for supporting a transducer off of the disc surface. The method includes the steps of forming a load/unload ramp, depositing a hardened film on the load/unload film, and depositing a lubricating film over the hardened film.

These and various other features as well as advantages which characterize the present invention will be apparent from a reading of the following detailed description and a review of the associated drawings.

### BRIEF DESCRIPTION OF THE DRAWINGS

FIG. 1 is a plan view of a disc drive incorporating a preferred embodiment of the present invention showing the load/unload ramp and other primary internal components.

FIG. 2 is an exploded perspective view of a load/unload ramp in accordance with a preferred embodiment of the present invention.

FIG. 3 is a sectional view taken along line 3-3 of FIG. 1 showing a hardening layer and lubricant layer in accordance with a preferred embodiment of the invention.

FIG. 4 is an exploded perspective view of an actuator arm traversing the load/unload ramp in accordance with a preferred embodiment of the present invention.

FIG. 5 is a flow chart of the method of preparing a load/unload ramp in accordance with a preferred embodiment of the present invention.

### DETAILED DESCRIPTION

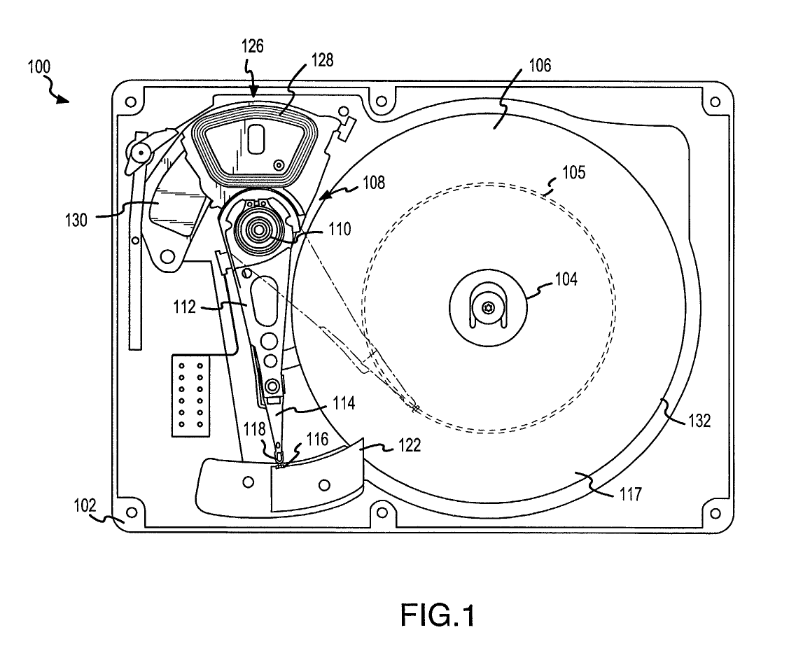

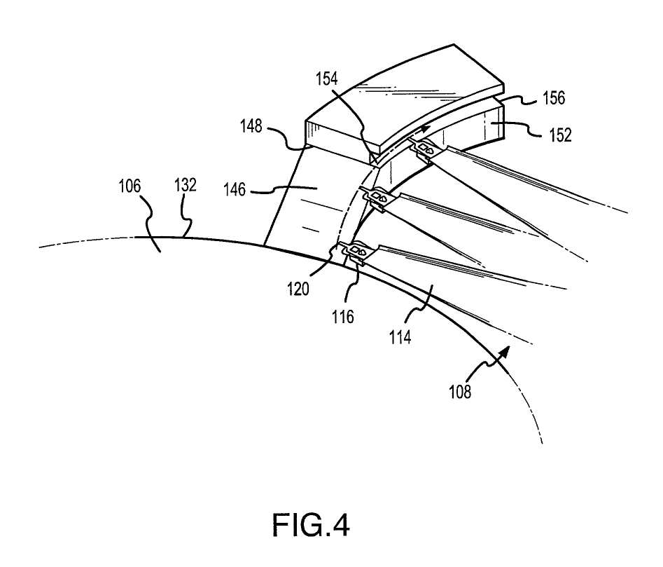

disc drive 100 constructed in accordance with a preferred embodiment of the present invention is shown in FIG. 1. The disc drive 100 includes a base 102 to which various components of the disc drive 100 are mounted. A top cover (not shown) cooperates with the base 102 to form an internal, sealed environment for the disc drive in a conventional manner. The components include a spindle motor 104, which rotates one or more discs 106 at a constant high speed. Information is written to and read from tracks 105 on the discs 106 through the use of an actuator assembly 108, which rotates during a seek operation about a bearing shaft assembly 110 positioned adjacent the discs 106. The actuator assembly 108 includes a plurality of actuator arms 112 which extend towards the discs 106, with one or more flexures 114 extending from each of the actuator arms 112. Mounted at the distal end of each of the flexures 114 is a transducer 116 which is embedded in an air bearing slider (not shown) enabling the transducer 116 to fly in close proximity above the corresponding surface 117 of the associated disc 106. Additionally, extending laterally from the distal end 118 of the flexure 114 is a lift tab 120 (see FIG. 4) for engagement with a load/unload ramp 122 as is described in greater detail below. Note that the flexure lift tab is used purely for illustrative effect, other structures for interaction with the load/unload ramp are also envisioned to be within the scope of the present invention.

During a seek operation, the track 105 position of the transducer 116 is controlled through the use of a voice coil motor (VCM) 126, which typically includes a coil 128 attached to the actuator assembly 108, as well as one or more permanent magnets 130 which establish a magnetic field in which the coil 128 is immersed. The controlled application of current to the coil 128 causes magnetic interaction between the permanent magnets 130 and the coil 128 so that the coil 128 moves in accordance with the well-known Lorentz relationship. As the coil 128 moves, the actuator assembly 108 pivots about the bearing shaft assembly 110, and the transducers 116 are caused to move across the surfaces of the discs 106.

The spindle motor 104 is typically de-energized when the disc drive 100 is not in use for extended periods of time. The transducers 116 are moved over the surfaces of the discs 106 to the load/unload ramp 122 located at the outer diameter 132 of the information storage discs 106. The transducers 116 traverse onto the load/unload ramp 122 and are secured in position through the use of an actuator latch arrangement (not shown), which prevents inadvertent rotation of the actuator assembly 108 when the transducers 116 are parked.

A flex assembly 136 provides the requisite electrical connection paths for the actuator assembly 108 while allowing pivotal movement of the actuator assembly 108 during operation. The flex assembly 136 includes a printed circuit board (not shown) to which head wires (not shown) are connected; the head wires being routed along the actuator arms 112 and the flexures 114 to the transducers 116. The printed circuit board typically includes circuitry for controlling the write currents applied to the transducers 116 during a write operation and a preamplifier for amplifying read signals generated by the transducers 116 during a read operation. The flex assembly 136 terminates at a flex bracket (not shown) for communication through the base deck 102 to a disc drive printed circuit board (not shown) mounted to the bottom side of the disc drive 100.

As briefly discussed above, the disc drive 100 has a load/unload ramp 122 in accordance with a preferred embodiment of the present invention for catching and securing the transducers 116 off of the disc 106 surfaces during a shutdown or standby condition. Because the actuator assembly 108 moves back and forth in an arcuate fashion between the inner radius and outer radius of the disc 106, the load/unload ramp 122 has a generally arcuate shape that aligns and lays in the path of movement of the distal tip of the actuator assembly 108 when the actuator arm swings to the outer diameter 132 of the disc 106.

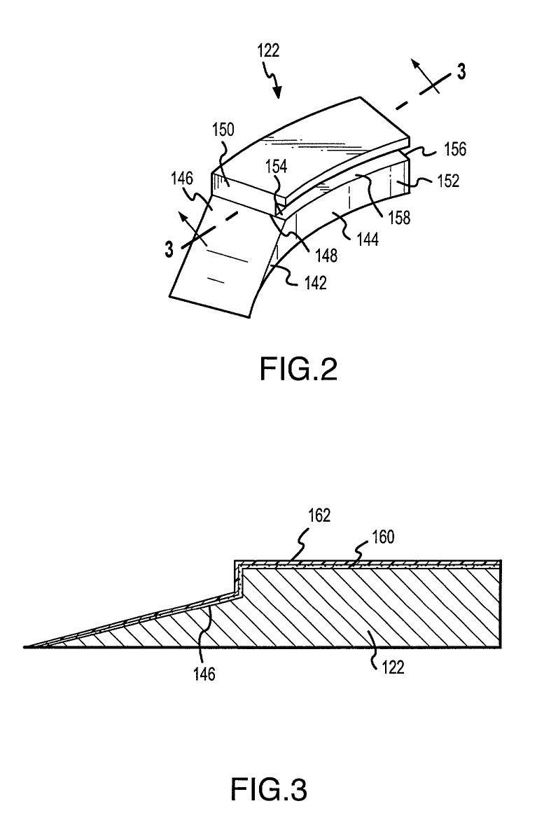

FIG. 2 is a perspective view of the load/unload ramp 122. The load/unload ramp 122 is typically secured to the base plate 102 at the outer diameter 132 of the information storage disc 106 so that the load/unload ramp 122 does not interfere with the operation of the transducer 116. The structure of the load/unload ramp 122 includes a pick-up portion 142, adjacent the outer diameter 132 of the information storage disc 106, and a storage portion 144 that extends away from the information storage disc 106. The pick-up portion 142 forms a generally curved wedge like structure having an inclined surface 146 for sliding engagement typically with the lift tab 120 at the distal tip of the flexure 114.

Extending from the pick-up portion 142 of the load/unload ramp 122 is a generally flat storage portion 144 of the load/unload ramp 122. In general, the storage portion 144 of the load/unload ramp 122 is a solid body having a side surface 152 that is curved complementary the arcuate movement of the actuator assembly 108. The storage portion 144 extends in a vertical direction slightly above and adjacent the top end 148 of the inclined surface 146 to form a wall and/or face 150. A horizontal groove or slot 154 is formed in the side 152 of the storage portion. The groove 154 extends from the wall 150, along the length of the storage portion 144, to the distal end 156 of the storage portion 144. The bottom surface 158 of the groove 154 is substantially parallel to the plane of rotation of the actuator and aligns with the top end 148 of the inclined surface 146 of the pick-up portion 142. The depth and height of the groove 154 is generally uniform and should preferably be sufficient for the acceptance of the flexure lift tab 120 so that when the actuator is rotated away from the disc 106, the flexure lift tab 120 rides up the inclined surface 146 and directly into and along the groove 154. The groove 154 functions to support the lift tab 120 and to prohibit vertical movement of the lift tab 120 by confining the lift tab 120 in the groove 154 during a shock event or disc drive shutdown or standby condition.

It should be noted that embodiments of the present invention are not limited to load/unload ramps 122 that support transducer heads on only one side of an information storage disc 106. Although only one load/unload ramp 122 is shown in the figures, embodiments of the present invention can function when the load/unload ramp 122 is configured to present on both sides of an information storage disc 106. The general configuration shown in FIGS. 2-4 would equally apply to a second ramp structure positioned adjacent the outer diameter of the bottom surface of the shown information storage disc 106. Further, the above description of the load/unload ramp 122 structure is for illustrative purposes only, any load/unload ramp 122 structure that interacts with the actuator assembly 108 to remove the transducer 116 from the information storage disc 106 is within the scope of the present invention, as the inventive features of the load ramp address problems not particularly dependent on any structural feature(s) of the load/unload ramp.

The load/unload ramp 122 is preferably composed of any disc drive 100 compatible polymers. Typically polymers for use with embodiments of the present invention are low friction-low wear plastics. Low friction-low wear plastics include, but are not limited to, members of the family of Liquid Crystal Polymers, such as Vectra A430, manufactured by Ticona, etc.

As shown in FIG. 3, a hard film 160 coats at least the inclined surface 146 and the bottom surface 158 of the horizontal groove 154 located along the storage portion 144 of the load/unload ramp. The hard film is harder than the low friction-low wear plastics used to form the load/unload ramp. As such, the hardened film 160 minimizes wear on, and debris formation from, the load/unload ramp 122 that results from the flexure lift tab 120 load/unload ramp 122 interaction. Suitable hardened films 160 applied to the load/unload ramp 122 must be hard, i.e., in the range of 70 GPQ and above, and thermally stable under normal disc drive operating conditions. Typical coating materials include, but are not limited to, carbon films such as diamond like carbon (DLC), silicon nitride films, titanium nitride films, titanium carbide films, etc. With regard to carbon films, the films can be hydrogenated, nitrogenated, or both hydrogenated and nitrogenated. Further, regular amorphous carbon deposited under a pure inert gas, such as argon, are also envisioned to be within the scope of embodiments of the present invention. Preferably, the load/unload ramp 122 is coated with a hydrogenated carbon film, such as hydrogenated DLC.

Typically, the thickness of the hardening coat 160 on the load/unload ramp 122 is at least about 100 Å with the maximum thickness being determined by diminishing cost effectiveness. Preferably, the hardening coat 160 is between about 100 Å, more preferably the hardening coat 160 is between about 100 Å and about 250 Å, and most preferably the hardening coat 160 is between about 100 Å and about 150 Å.

Typically, prior to application of the hardening coat 160 to the load/unload ramp 122, the load/unload ramp 122 is cleaned and rinsed with acetone and rinsed with ID water. The cleaning process facilitates removal of organic grease as well as enhances the adhesion between the load/unload ramp and deposited hardened coat 160. Preferably, the cleaning step is accompanied with ultrasonic vibration in the range of 25 to 50 kHz, which also facilitates the elimination of dirt, grease, oil, etc from the load/unload ramp 122 surfaces. The frequency of the ultrasound can be modified above or below 25 to 50 kHz dependent on the effectiveness of the cleaning procedure. As such, the load/unload ramp 122 is immersed in a bath of acetone and subjected to ultrasound, removed from the bath, and preferably rinsed with either acetone or alcohol. The cleaned load/unload ramp is next immersed in a bath of ID water and preferably subjected to a second round of ultrasonic vibration, again in the range of 25 to 50 kHz, in the bath of ID water.

The hardening surface 160 is typically deposited on the load/unload ramp using any number of different sputtering methods. Typical methods include, but are not limited to, direct current (DC) and alternate current (AC) magnetron sputtering, radio frequency (RF) diode sputtering, DC diode sputtering, RF magnetron sputtering, DC magnetron sputtering, AC magnetron sputtering, high-energy source sputtering, and ion beam sputtering. Typically, the sputtering techniques are performed in an in-line pass-by sputtering system although static sputtering systems are also envisioned to be within the scope of embodiments of the present invention. Preferably, the hardening surface 160 is applied with a superimposed direct current (DC) and alternate current (AC) magnetron sputtering in an in-line pass-by sputtering system.

By way of example, a load/unload ramp 122 was coated with hydrogenated carbon film. The DLC film was deposited under a pressure of 18 mTorr of a 15% hydrogen/85% argon premixed gas. Power density of the deposition was 83 Watts/in² and the deposition rate onto the load/unload ramp was approximately 3.5 Å/second. The carbon film was deposited under 50° C. of substrate temperature to avoid degassing of the plastic.

A lubricant layer 162 is added to the hardened coated load/unload ramp to minimize the friction coefficient between the lift tab 120 and the hardened coat 160 on the load/unload ramp 122. Friction coefficients below 0.2, and preferably below 0.15, are required for optimal lift tab 120 to load/unload ramp 122 interactions. Lubricants for use with embodiments of the present invention must be compatible with the disc drive 100 and can include, but are not limited to, perfluoropolyether, etc. Thickness of the lubricant layer 162 is between about 200 Å and about 500 Å, preferably between about 200 Å and 350 Å, and most preferably between about 200 Å and 250 Å. Lubricant layer 162 thicknesses greater than about 550 Å tends to lead to the formation of lubricant droplets that can contaminate the interior of the disc drive 100. Alternatively, lubricant layer 162 thickness less than about 150 Å tends not to provide sufficient lubricant properties to the hardening surface 160 coated on the load/unload ramp 122.

Thickness of the lubricant layer 162 is controlled by the concentration of the lubricant applied to the load/unload ramp. As such, lubricants are typically applied to the load/unload ramp 122 as a mixture of % lubricant in a solvent. Typical manufactured brand name lubricants include Z-Tetraol, Z-DOL, Z-TX and X1P. Typical manufactured solvents for use with the above mentioned lubricants include, but are not limited to, HFE, AK225 and PF5060.

Application of the lubricant layer 162 to the hardened coated load/unload ramp is preferably performed by placing the hardening coated load/unload ramp in a lubricant-containing bath in conjunction with ultrasonic vibration. As above, ultrasonic frequency typically ranges between 25 and 50 kHz although other frequencies can be utilized. The ultrasonic vibration helps remove trapped air and lower surface tension from the load/unload ramp surfaces and thus provides for a uniform lubricant layer 162 on the hardened coat 160. Typically, the ultrasonic vibration is discontinued after a short period so that the load/unload ramp 122 can undergo a short static soaking in the lubricant bath.

The following provides an example of application of the lubricant layer 162 to the load/unload ramp 122: a carbon coated load/unload ramp is soaked in a lubricant bath containing 1% gram/gram of Z-Tetraol/Vertrel®. The load/unload ramp is soaked in the bath for 30 seconds while undergoing ultrasonic vibration in the range of 25 kHz to 50 kHz, followed by 15 seconds of static soaking in the same lubricant mixture. As noted above, lubricant thickness on the load/unload ramp is controlled by the concentration of the lubricant in the lubricant bath. For example the working concentration of the lubricant in Vertrel solvent is typically in the range of 0.3% gram/gram to 10% gram/gram by weight.

With reference to FIG. 4, when the transducer 116 is to be removed from the information storage disc 106, the actuator assembly 108 is pivoted to the outer diameter 132 of the disc until the lift tab 120 engages and rides along the inclined surface 146 of the pick-up portion 142 of the load/unload ramp 122. The lift tab continues to the top end of the inclined surface and continues along the groove until it comes to rest through actuation of the actuator latch assembly.

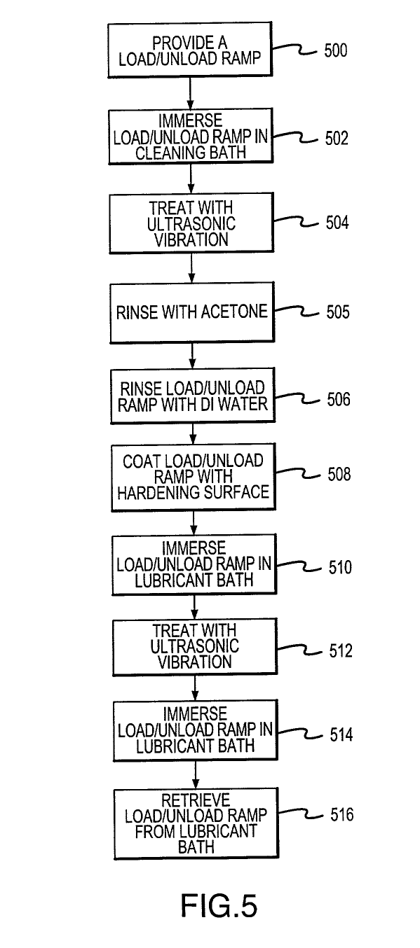

One method for preparing a load/unload ramp having a hardened coat and lubricant layer is shown in FIG. 5. In Operation 500, a load/unload ramp is provided or formed. Process control then transfers to Operation 502. In Operation 502 the load/unload ramp is immersed in a cleaning bath, typically composed of acetone or other like material. Process control then transfers to Operation 504. In Operation 504, while immersed in the acetone bath the load/unload ramp is exposed to ultrasonic vibration in the range of 25 to 50 kHz. Process control then transfers to Operation 505. In Operation 505, the load/unload ramp is rinsed with acetone. Process control then transfers to Operation 506. In Operation 506 the acetone and any associated material is rinsed from the load/unload ramp with DI water and may optionally be treated with ultrasonic vibration. Process control then transfers to Operation 508. In operation 508 the load/unload ramp is coated with a hardened surface, typically through sputtering of a carbon film, having a thickness of 100 to 500 Å onto the cleansed load/unload ramp surfaces. Process control then transfers to Operation 510 followed by Operation 512. In Operations 510 and 512 the hardened coated load/unload ramp is treated with ultrasonic vibration while immersed in a lubricant bath to break-up and release any trapped air on the load/unload ramp surfaces. Process control then transfers to Operation 514. In Operation 514, ultrasonic vibration is discontinued and the load/unload ramp remains immersed in a static lubricant bath. Finally, process control transfers to Operation 516, where the load/unload ramp is removed from the static lubricant bath and allowed to dry.

In summary, a preferred embodiment of the invention described herein is directed to a disc drive (such as 100) having an information storage disc (such as 106) rotatably mounted on a spin motor (such as 104). The disc drive includes an actuator assembly (such as 108) for directing a transducer (such as 116) over a surface (such as 117) of the information storage disc (such as 106), and a load/unload ramp (such as 122) positioned adjacent a peripheral portion (such as 132) of the information storage disc (such as 106) for supporting the transducer (such as 116) when the transducer is off of the information storage disc. The load/unload ramp (such as 122) is coated with a hardened film (such as 160).

In another preferred embodiment of the invention the hardened film material is carbon based, silicon nitride or titanium carbide.

In another preferred embodiment of the invention the hardened film (such as 160) has a thickness of between 100 Å and 500 Å.

In another preferred embodiment of the invention the hardened film (such as 160) has a thickness of between 100 Å and 250 Å.

In another preferred embodiment of the invention the hardened film (such as 160) has a thickness of between 100 Å and 150 Å.

In another preferred embodiment of the invention the hardened film (such as 160) is covered with a disc drive compatible lubricant layer (such as 162).

In another preferred embodiment of the invention the lubricant layer (such as 162) is composed of perfluoropolyether.

In another preferred embodiment of the invention the lubricant layer (such as 162) is between 200 Å and 500 Å thick.

In another preferred embodiment of the invention the lubricant layer (such as 162) is between 200 Å and 350 Å thick.

Another preferred embodiment of the invention described herein is directed to a method of reducing debris formation in a disc drive where the disc drive includes an information storage disc (such as 106) rotatably mounted on a spin motor (such as 104), an actuator assembly (such as 108) adjacent the information storage disc (such as 106), and a load/unload ramp (such as 122) adjacent the information storage disc (such as 106) for supporting a transducer (such as 116) off of the disc (such as 106). The method includes the steps of providing or forming a load/unload ramp (such as in step 500), depositing a hardened film on the load/unload ramp (such as in step 508), and depositing a lubricating film over the hardened film (such as in step 510 or 514).

In another preferred embodiment of the invention the method further includes the steps of ultrasonically vibrating the load/unload ramp while the ramp is immersed in an acetone bath (such as in step 502), and rinsing the load/unload ramp with DI water (such as in step 506) prior to depositing a hardened film on the load/unload ramp. The hardening film may be deposited on the load/unload ramp using a sputtering technique.

In another preferred embodiment of the invention the method further includes the steps of ultrasonically vibrating the load/unload ramp while the ramp is immersed in a lubricant bath (such as in step 510 and 512) and removing the ramp from the lubricant bath (such as in step 516).

In another preferred embodiment of the invention the method further includes the step of soaking the load/unload ramp in the lubricant bath (such as in step 514) after first ultrasonically vibrating the load/unload ramp in the lubricant bath.

It will be clear that the present invention is well adapted to attain the ends and advantages mentioned as well as those inherent therein. While a presently preferred embodiment has been described for purposes of this disclosure, various changes and modifications may be made which are well within the scope of the present invention. Numerous other changes may be made which will readily suggest themselves to those skilled in the art and which are encompassed in the spirit of the invention disclosed and as defined in the appended claims.

What is claimed is:

1. A disc drive having an information storage disc rotatably mounted on a spin motor, the disc drive comprising:
an actuator assembly for directing a transducer over a surface of the information storage disc; and
a load/unload ramp positioned adjacent a peripheral portion of the information storage disc for supporting the transducer when the transducer is off of the information storage disc, wherein the load/unload ramp is coated with a hardened film.

2. The disc drive of claim 1 wherein the hardened film material is selected from the group consisting of a carbon based film, a silicon nitride based film, a titanium nitride film and a titanium carbide based film.

3. The disc drive of claim 1 wherein the hardened film is between 100 Å and 500 Å thick.

4. The disc drive of claim 1 wherein the hardened film is between 100 Å and 250 Å thick.

5. The disc drive of claim 1 wherein the hardened film is between 100 Å and 150 Å thick.

6. The disc drive of claim 1 wherein the hardened film is covered with a disc drive compatible lubricant.

7. The disc drive of claim 6 wherein the lubricant film material is perfluoropolyether.

8. The disc drive of claim 6 wherein the lubricant film is between 200 Å and 500 Å thick.

9. The disc drive of claim 6 wherein the lubricant film is between 200 Å and 350 Å thick.

10. A method of reducing debris formation in a disc drive wherein the disc drive has an information storage disc rotatably mounted on a spin motor, an actuator assembly adjacent the information storage disc for directing a transducer over a surface of the information storage disc, and a load/unload ramp adjacent the information storage disc for supporting a transducer off of the disc, the method comprising steps of:
(a). forming a load/unload ramp;
(b). depositing a hardened film on the load/unload ramp; and
(c). depositing a lubricating film over the hardened film of the load/unload ramp.

11. The method according to claim 10 wherein the hardened film depositing step (b) further comprises the steps of:
(b)(i) ultrasonically vibrating the load/unload ramp while the load/unload ramp is immersed in an acetone bath;
(b)(ii) rinsing the load/unload ramp with DI water; and
(b)(iii) depositing a hardened film on the load/unload ramp.

12. The method according to claim 10 wherein the lubricating film depositing step (b) further comprises the steps of:
(c)(i) ultrasonically vibrating the load/unload ramp while the load/unload ramp is immersed in a lubricant bath; and
(c)(ii) removing the load/unload ramp from the lubricant bath.

13. The method according to claim 10 wherein the lubricating film depositing step (b) further comprises the steps of:
(c)(i) ultrasonically vibrating the load/unload ramp while the load/unload ramp is immersed in a lubricant bath;
(c)(ii) soaking the load/unload ramp in the lubricant bath; and
(c)(iii) removing the load/unload ramp from the lubricant bath.

14. The method according to claim 10 wherein the hardened film depositing step (b) further comprises the steps of:
(b)(i) ultrasonically vibrating the load/unload ramp while the load/unload ramp is immersed in an acetone bath;
(b)(ii) rinsing the load/unload ramp with DI water; and
(b)(iii) sputtering a hardened film on the load/unload ramp using a sputtering method selected from the group consisting of direct current (DC) and alternate current (AC) magnetron sputtering, RF diode sputtering, DC diode sputtering, RF magnetron sputtering, DC magnetron sputtering, AC magnetron sputtering, high energy source sputtering, and ion beam sputtering.

15. A disc drive load/unload ramp for reducing debris formation in a disc drive, the load/unload ramp comprising:
a load/unload ramp formed from a low friction-low wear polymer; and
means over the polymer for reducing debris formation inside the disc drive.
